(19) United States
(12) Patent Application Publication
(10) Pub. No.: US 2025/0154848 A1
(43) Pub. Date: May 15, 2025

(54) Downhole Tools Having Elastomer Blend For Geothermal Wellbores

(71) Applicant: Halliburton Energy Services, Inc., Houston, TX (US)

(72) Inventors: Chad W. Glaesman, Singapore (SG); Sandeep Thatathil, Singapore (SG)

(73) Assignee: Halliburton Energy Services, Inc., Houston, TX (US)

(21) Appl. No.: 18/507,353

(22) Filed: Nov. 13, 2023

(51) Int. Cl. E21B 33/12; C08J 3/24

(52) U.S. Cl. CPC E21B 33/12; C08J 3/242; C08J 2323/16; C08J 2383/04

(57) ABSTRACT

A variety of methods and apparatus are disclosed, including, in one embodiment, a downhole tool for a wellbore in geothermal service, the downhole tool having a component comprising a blend of ethylene propylene diene monomer (EPDM) and silicone, wherein the blend is vulcanized.

### BACKGROUND

Borcholes (wellbores) drilled into subterranean formations may be utilized to recover geothermal heat. Operations may be performed before, during, and after the borehole has been drilled to produce and continue the flow of steam or hot liquid water to the surface. Downhole tools in the borehole or wellbore may facilitate the production of water (e.g., steam) from the subterranean formation.

Geothermal heat may be carried (e.g., by liquid water or steam) from a subterranean formation in the Earth crust through a geothermal wellbore to the Earth surface. The geothermal heat may be utilized for heating, electricity generation, and other applications. Geothermal power (generation of electricity from geothermal energy) has been used since the 20th century. Unlike wind and solar energy, geothermal plants may produce power at generally a constant rate without regard to weather conditions. Geothermal energy can be characterized as a renewable energy source because heat is continuously produced inside the earth. Geothermal power can be considered renewable energy because the heat extraction is insignificant compared with the heat content of the Earth. The greenhouse gas emissions of geothermal electric stations are typically less than 5 percent of that of coal-fired plants. Enhanced geothermal systems (EGS) actively inject water into wells to be heated and pumped back out. The water may be injected under high pressure to expand existing rock fissures to enable the water to flow freely.

Geothermal resources include reservoirs of hot water that exist or are human made at varying temperatures and depths below the Earth surface. Wells including wellbores ranging from a few feet to several miles deep can be drilled into underground reservoirs to tap steam and hot liquid water that can be brought to the surface for use in applications such as electricity generation, direct use, and heating and cooling.

### BRIEF DESCRIPTION OF THE DRAWINGS

These drawings illustrate certain aspects of some of the embodiments of the present disclosure and should not be used to limit or define the disclosure.

FIG. 1 is a diagram of a geothermal system including a downhole tool in a wellbore in geothermal service.

FIG. 2 is diagram of an example technique for blending ethylene propylene diene monomer (EPDM) and silicone to give a polymer blend for a component (e.g., sealing element) of a downhole tool.

FIG. 3 is a diagram of an example of a two roll mill that can be utilized as a mixer to blend EPDM and silicone.

FIG. 4 is a diagram of an example of an internal mixer that can be utilized to blend EPDM and silicone.

FIG. 5A is a diagram of a compression mold in an open position.

FIG. 5B is a diagram of the compression mold of FIG. 5A but in a closed position.

FIG. 6 is a plot of tensile stress and tensile strain over the silicone loading of the original blends of EPDM and silicone in the Example, and gives curves for values of certain properties from Table 2.

FIG. 7 is a plot of percent change over silicon loading levels in the EPDM in the Example, and gives curves for percent change in certain properties from Table 3.

### DETAILED DESCRIPTION

Disclosed herein are blends of ethylene propylene diene monomer (EPDM) and silicone as material applicable for the downhole high-temperature steam environment of geothermal heat recovery. Some aspects of the present disclosure are directed to downhole tools configured for wellbores in geothermal service, and in which the downhole tools (e.g., packer, expandable liner hanger, etc.) have a component (e.g., sealing element) that includes a vulcanized blend of EPDM and silicone. The weight ratio of the EPDM to the silicone may be, for example, in the range of 5:95 to 40:60. The blend can have reinforcing filler material.

Elastomers utilized in the oil and gas industry, such as nitrile butadiene rubber (NBR) (also known as nitril rubber), hydrogenated nitrile butadiene rubber (HNBR), fluorine kautschuk material (FKM) (also known as fluorine rubber or fluoro-rubber), tetrafluoroethylene propylene (FEPM or the tradename AFLAS®) (a partially fluorinated polymer that is a copolymer of tetrafluoroethylene and propylene), and perfluoroelastomer (FFKM) (higher amounts of fluorine than standard FKM), generally have limited service in high temperatures typically experienced in geothermal applications. Moreover, materials in geothermal applications generally require little or no oil resistance.

Embodiments herein include blends of EPDM (with silicone) as a material for geothermal service. The term “EPDM” can be a shortened term meaning “EPDM rubber,” “EPDM polymer,” and “EPDM elastomer.” EPDM is a type of polymer (elastomer, synthetic rubber) utilized across various industries. EPDM is generally an ethylene propylene diene terpolymer. EPDM is made from ethylene, propylene, and diene monomers and is a versatile and durable type of rubber with numerous applications. The diene(s) can be, for example, in the range of 4% to 8% by weight of these monomers in forming the EPDM terpolymer. Dienes as a comonomer in the synthesis of EPDM polymer (rubbers) may be, for example, ethylidene norbornene (ENB), dicyclopentadiene (DCPD), vinyl norbornene (VNB), etc. The curing (vulcanization, crosslinking) of EPDM may be facilitated by crosslinkers or curing agents, such as peroxides [e.g., dicumyl peroxide (DCP)], phenolic resins (e.g., phenol-formaldehyde resins or resol-resins), hydrosiloxanes, and so on. Moreover, in application, EPDM may typically include filler material, such as carbon black, silica particles, and so forth.

The present polymer blends having EPDM for higher-temperature application may satisfy upper temperature demands for geothermal service. Such may address the increase in service needs for newer geothermal fields due to increasing focus on renewable energy sources.

Embodiments may include downhole tools for a wellbore in geothermal service and in which the downhole tool has an elastomer compound of a continuous phase of compounded EPDM elastomer blended and co-cured (co-vulcanized) with silicone or liquid silicone rubber. Silicone gives good thermal stability but typically lacks sufficient strength and oil resistance for most oil and gas environments. In this polymer blend with EPDM, silicone functions as a non-extractable high temperature plasticizer/modifier that may generally remain thermally stable and thus flexible within the continuous and stronger phase of EPDM that loses elasticity due to the aging process. Silicone is a good option for blending with EPDM because both polymers are non-polar and can be vulcanized by the same or similar cure ingredients. As mentioned, the blends can include a weight ratio of silicone to EPDM, for example, in the range of 5:95 to 40:60. The polymer blends including silicone and EPDM can be formed in which the EPDM phase of the blend overcomes the strength limitations of silicone while the thermal stability of the silicone counters the aging limitations of EPDM. In implementations, silicone and EPDM in a blended formation have synergistic relationship where each compensates for the specific weaknesses of the other to solve challenges specific to the high temperature service demands of geothermal applications.

Silicone has an inorganic silicon-oxygen (Si—O) backbone. Silicone, also called polysiloxane, is a family of materials based on polymerized siloxanes. “Silicone” is a generic term referring to a class of synthetic polymers that are based on a framework of alternating silicon and oxygen (siloxane) bonds with an organic group attached to the silicon atom via a direct carbon-silicon bond. In implementations, silicone is a polymer composed of repeating units of siloxane (—R₂Si—O—SiR₂—, where R is an organic group). Thus, silicone materials have repeating units of inorganic —SiO₂— as the backbone structure, with methyl or other functional groups as —Si— side groups. Most polysiloxanes feature organic substituents, e.g., [(CH₃)₂SiO]ₙ and [(C₆H₅)₂SiO)]ₙ, in which C is carbon and His hydrogen.

EPDM based elastomers are generally considered to be good high temperature and steam resistant materials and can be utilized for moderately high temperature geothermal, steam, and enhanced oil recovery (EOR) applications. Silicone based elastomers have high temperature service envelopes. A drawback of silicone (alone) is limited strength properties of silicon that disfavor use of silicone (alone) in applications requiring exceptional high temperature resistance to extrusion or other mechanical damage like those experienced in geothermal or steam injection applications. Blending of the two polymers (silicone and EPDM) balances the strength of the EPDM with the thermal stability of the silicone rubber to produce a material both thermally stable at high temperature and with sufficient strength to function as a seal against high differential pressures.

Table 1 gives a relative property comparison of EPDM, silicone, and EPDM-silicone blend in which the weight ratio of silicone to EPDM is in the range of 5:95 to 40:60. A legend for the comparative numerical values is given below the table. The properties are low temperature sealing below −50° C., high temperature performance, high temperature steam resistance, high pressure sealing performance, and oil resistance.

TABLE 1
Property Comparison

| | | | EPDM-Silicone |
|---|---|---|---|
| | EPDM | Silicone | Blend |
| Low Temperature Sealing | 2 | 5 | 4 |
| properties below −50° C. | | | |
| High Temperature performance | 4 | 5 | 5 |
| High Temperature Steam | 5 | 4 | 5 |
| exposure resistance | | | |
| High pressure sealing | 5 | 2 | 4 |
| performance | | | |
| Oil Resistance | 2 | 1 | 2 |

5—Excellent
4—Very Good
3—Good
2—Fair
1—Poor

In embodiments, traditional manufacturing equipment can be utilized to achieve (prepare, form) the polymer blends (elastomer blends) of EPDM and silicone (or fluorosilicone). The blending of the EPDM with the silicone may be performed at the gum rubber stage utilizing, for example, an internal mixer or a traditional two-roll mill. Internal mixers are general purpose machines capable to mix a range of rubber or elastomer compounds. Internal mixers include a chamber to which the compounding ingredients are added. In the chamber are two rotors that generate shear forces, dispersing the fillers and other raw materials in the polymer, resulting in a relatively a uniform mixture or compound. The two roll mill is a machine historically utilized to process natural rubber into various blends as mixtures or compounds. The two roll mill includes horizontally opposed stainless steel rolls that rotate in opposite directions towards each other at different respective speeds to mix the rubber (or elastomer) and ingredients added to form the rubber or elastomer blend compound. Other types of mixers or blenders may be utilized form the EPDM-silicone blend. For pre-blending of elastomers, a brabender or extruder may be employed before the internal mixer or two-roll mill is employed.

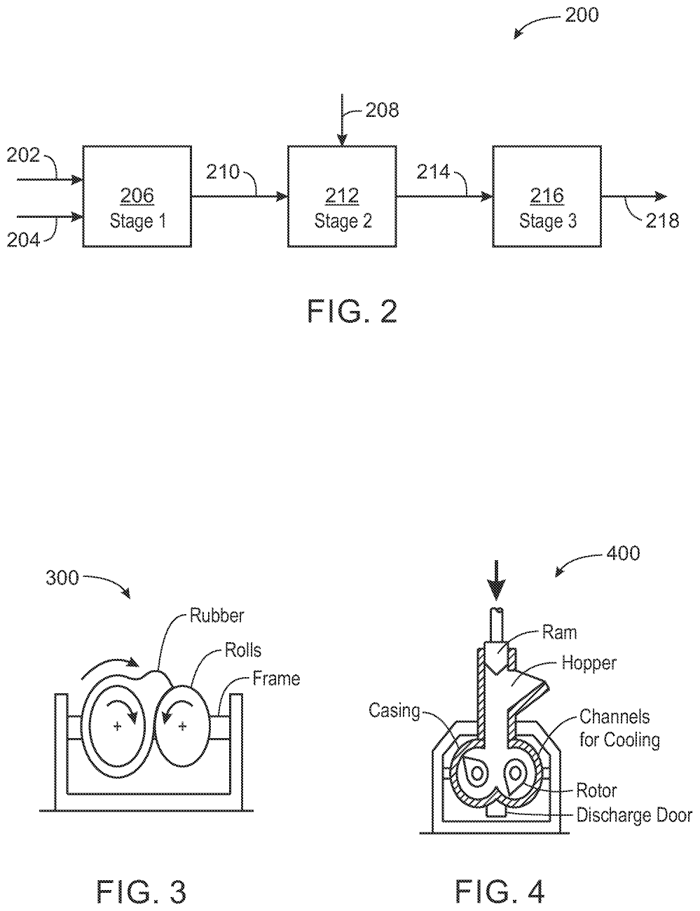

In implementations, a blending system and process (e.g., internal mixing or mill mixing techniques) can masticate both elastomers (EPDM and silicone) and blend the EPDM and silicone together. Compounding ingredients including reinforcing filler and curatives are generally added to the gum polymer (e.g., through intermix) and the resulting blend mixture then vulcanized (cured) utilizing, for example, compression or transfer molding. In the blending of the silicone with the EPDM in the mixer (e.g., internal mixer or two-roll mill), fillers and softeners (softener additives) can be added to the EPDM to reduce the viscosity of the continuous EPDM phase to facilitate dispersion of the silicone in the EPDM by making the viscosities of the two materials more similar. The softener (e.g., polyethylene wax, polyisobutylene, liquid isoprene, liquid ethylene propylene rubber, rubber oil, paraffin oil, a plasticizer, etc.) can be added to or mixed (e.g., as a compounding additive) with the EPDM before blending the silicone with the EPDM, or added during the blending of the silicone with the EPDM. Examples of manufacturing techniques for blending the EPDM and silicone are discussed with respect to FIGS. 2-4. Compression molding is a technique that involves the compression of pre-formed and/or pre-heated raw material in a heated mold cavity. Transfer molding is similar to compression molding except that instead of the molding material is pressurized in a separate chamber and then forced through an opening into the closed mold.

The product formed from the EPDM/silicone blend and that is the downhole tool component having the EPDM/silicone blend can be produced through elastomer manufacturing techniques. These techniques include, for example, extrusion, calendaring, strip wrapping/roll building, injection molding, transfer molding, compression molding, and so on. These products or components can be thin cross-sectional seals (sealing elements) like O-rings, V-Packing, T-seals and bonded/molded seals, or thicker cross-sectional seals like packing elements, rotating control device (RCD) elements, swell packers, and bonded expandable liner hangers.

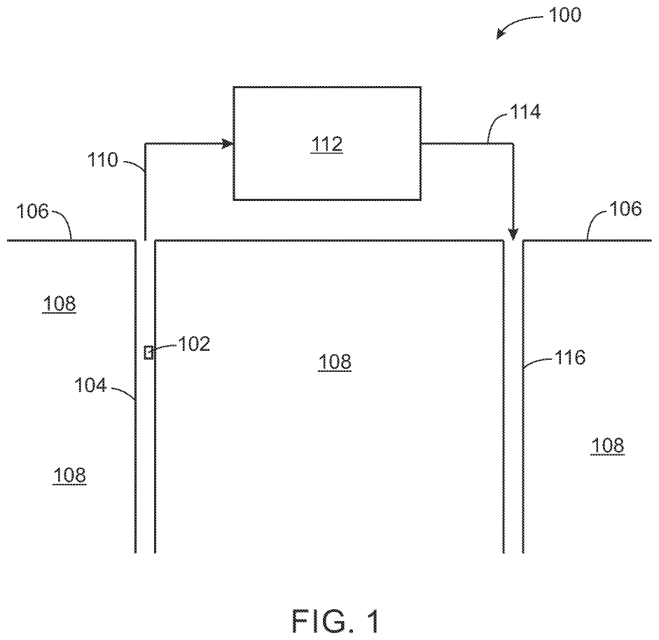

FIG. 1 is a geothermal system 100 including a downhole tool 102 in a wellbore 104 in geothermal service. The wellbore 104 can be labeled as a geothermal wellbore. The downhole tool 102 is for a wellbore in geothermal service. The downhole tool 102 may be positioned at a target location (e.g., depth) in the wellbore 104. While the wellbore 104 is depicted as vertical, the present techniques are applicable to geothermal wellbores that are horizontal wellbores, deviated wellbores, multilateral wells, and the like.

The downhole tool 102 includes a polymer blend of EPDM polymer and silicone, as discussed. As mentioned, the weight ratio of EPDM to silicone can be, for example, in the range of 5:95 to 40:60. The polymer blend can include additional components. The polymer blend in the downhole tool 102 may be, for example, a sealing element (seal) or similar component of the downhole tool 102.

The downhole tool 102 may be, for example, a packer (e.g., isolation packer, production packer, etc.), plug (e.g., bridge plug, frac plug, etc.), expandable liner hanger (ELH), rotating control device (RCD), a valve, an injection port, and so forth. Again, the downhole tool 102 may include the present polymer blend (elastomer blend) of EPDM and silicone as a seal (scaling element) in examples. The component of the downhole tool 102 having or as the polymer blend can be, for example, seals (cross-sectional seals) that are relatively thin, such as O-rings, V-packing (Vee-packing, e.g., multiple-lip seals), T-seals (e.g., having a T-shaped cross section and two backup rings), and bonded molded seals (e.g., engineered or custom molded seals as an inner component that can be bonded to an external hard material such as steel), and so forth. The component can be seals (cross-sectional seals) that are relatively thick, such as a sealing element of a packer (including swell packers), sealing element of a rotating control device (RCD), sealing element of an expandable liner hanger, and so on. A valve as the downhole tool (or as a part of a downhole tool) may include a seal that is or includes the polymer blend. An injection port as part a downhole tool may include the component having the polymer blend.

The wellbore 104 is formed through the Earth surface 106 into a subterranean formation 108 in the Earth crust. In operation, steam 110 (water vapor) may be produced from the formation 108 to the surface 106 via the wellbore 104. Hot liquid water may be produced from the formation 108 to the surface 106 via the wellbore 104. The steam 110 (and/or any produced hot liquid water) may carry geothermal energy (geothermal heat) for use at the surface 106. The source of the steam 110 (or hot liquid water) may be, for example, a water zone, a water aquifer, water in rock pores, and so on, in the subterranean formation 106. The water can be native water in the formation 108 and/or water that has been injected into the formation 108 from the surface 106.

The steam 110 discharged from the wellbore 104 can be routed to a user 112 that recovers and utilizes the geothermal heat carried by steam 110. In examples, the user 112 can utilize the geothermal heat for direct use that gives or produces heat directly from the steam 110 and/or from associated hot liquid water. In other instances, the user 112 can be heat pumps, for example, that heat (and cool) buildings.

The user 112 can be a geothermal power plant for electricity production that generates electricity. The geothermal power plant can have a turbine (e.g., steam turbine) coupled to an electrical generator. In operation, the received steam 110 rotates the turbine that drives (turns) the electrical generator that produces electricity. The steam 110 can be condensed. In certain implementations, the steam condensate 114 (liquid water) is injected into the subterranean formation 108 via an injection wellbore 116. The steam condensate can instead be injected into a subterranean formation other than the formation 108. Three common types of geothermal power plants are dry steam, flash steam, and binary cycle.

The wellbore 104 can have a casing or be openhole. The wellbore 104 can have both cased portions and openhole portions. For instances with a casing employed, cement may be disposed between the casing and the formation 108 face. The formation 108 face can be considered a wall of the wellbore 104. Perforations may be formed through the casing (and cement) for entry of fluid (e.g., water, steam 110, etc.) from the subterranean formation 108 into the wellbore 104 to be produced through the wellbore 104 to the surface 106.

In implementations, the fluid (e.g., water, steam 110, etc.) can be routed as produced fluid through production tubing in the wellbore 104 to the surface 106. The production tubing may be a tubing string utilized in the production of the steam 110. In certain implementations, the downhole tool 102 may be disposed on or near production tubing.

Surface equipment situated at the surface 106 adjacent the wellbore 104 may include a wellhead for initial receipt of the produced fluid (steam 110 and any other produced fluid). The surface equipment can include a hoisting apparatus (e.g., for raising and lowering pipe strings) and a derrick. The surface equipment and equipment deployed in the wellbore 1004 can include equipment, such as a wireline, slickline, coiled tubing, tubing string, pipe, drill pipe, drill string, and the like, that facilitates mechanical conveyance for deploying downhole tools (e.g., 102).

The deploying of a downhole tool (e.g., 102) may include lowering the downhole tool into the wellbore 104 from the surface 106 and setting (e.g., via mechanical slips) the downhole tool in the wellbore 104. In some implementations for the downhole tool 102 as a packer, the equipment (e.g., wireline) may provide electrical connectivity, for example, to actuate the packer 102 to seal off a portion of the wellbore 104.

For the downhole tool 102 as a packer, the packer may be permanently set or retrievable, mechanically set, hydraulically set, and/or combinations thereof. The packer may be set in a cased portion of the wellbore 104 or in an openhole portion of the wellbore 104. The packer may include one or more sealing elements (e.g., expandable seal elements) having the present polymer blend of EPDM and silicone. The packer may be set downhole to seal off a portion of the wellbore 104. When set, the packer may isolate zones of the annulus between the casing and the production tubing (e.g., a tubing string) by providing a seal (fluid seal) between the production tubing and the casing or liner. In examples, the packer may be disposed on the production tubing. The packer may provide a seal between the packer and an adjacent surface, such as the casing or a liner. Moreover, for the downhole tool 102 as a plug or other downhole tool, a sealing element having the polymer blend of EPDM and silicone may be similarly utilized.

An embodiment is a method of deploying a downhole tool into a geothermal wellbore (e.g., wellbore 104), including lowering the downhole tool into the geothermal wellbore and positioning the downhole tool at a target location in the geothermal wellbore. The downhole tool has a component including a blend of EPDM and silicone, wherein a weight ratio of the EPDM to the silicone is in a range of 5:95 to 40:60, and wherein the EPDM and the silicone are vulcanized. The component may be, for example, a sealing element, a seal, a bonded seal, an O-ring. V-packing, a T-seal, or any combinations thereof. The downhole tool may be, for example, a packer, a plug, an expandable liner hanger (ELH), a rotating control device (RCD), or a valve, and so on. The blend of EPDM and silicone may have a reinforcing filler material (particles or fibers, or both) in a range of 0% to 50% by weight or 1% to 50% by weight. The combined amount of the EPDM and the silicone is at least 45% by weight of the blend, for instance, in the ranges of 45% to 60%, 45% to 80%, 45% to 90%, 45% to 95%, and 45% to 99%.

The EPDM and the silicone may be blended, for example, via a two roll mill or an internal mixer to give the blend. The component is then formed by molding the resulting blend, such as in transfer molding or compression molding. Compression molding is a technique of molding in which the molding material (the blend), generally preheated, is placed in an open, heated mold cavity. The mold is closed with a top force or plug member, pressure is applied to force the material into contact with all mold areas, while heat and pressure are maintained until any curing or vulcanization of the molding material (blend of EPDM and silicone) is completed. In the similar technique of transfer molding, the blend is pressurized in a separate chamber and then forced into the closed mold.

FIG. 2 is an example technique 100 that may represent a system and/or a method for blending the EPDM 202 and the silicone 204 to give a polymer blend for a component (e.g., sealing element) of a downhole tool. As discussed, EPDM is a type of polymer (elastomer, synthetic rubber) utilized across various industries. Developed in the early 1960s, EPDM is an ethylene propylene diene terpolymer. EPDM is made from ethylene, propylene, and diene monomers.

As also mentioned, silicone (polysiloxane) is class of fluids, resins, or elastomer based on polymerized siloxanes, substances whose molecules include chains of alternating silicon and oxygen atoms. Polysiloxanes (polymerized siloxanes) as silicones include an inorganic silicon-oxygen backbone chain ( . . . —Si—O—Si—O—Si—O . . . ) with two groups attached to each silicon (Si) center.

The silicone 204 can be or include fluorosilicone. Fluorosilicone is a variation of silicone rubber that maintains high temperature stability and mechanical properties, while offering greater resistance to fuel, oil and other chemicals. These added benefits also come with a cost in that fluorosilicone is more expensive than silicone, e.g., typically about five times the cost of silicone. Fluorosilicone can be a class of polymers including a siloxane backbone and fluorocarbon pendant groups.

At stage 1, a mixer 206 is utilized to blend the EPDM 202 and the silicone 204. The mixer 206 (blender) may be, for instance, a two roll mill (e.g., FIG. 3) or an internal mixer (e.g., FIG. 4), and the like.

The EPDM 202 and silicone 204 may be combined before addition to the mixer 206. In implementations, the EPDM 202 and silicone 204 are pre-blended before addition to the mixer 206, such as in a pre-mixer or extruder (e.g., a Brabender® extruder by Brabender GmbH & Co. KG having headquarters in Duisburg, Germany). However, pre-blending is optional and is not implemented in certain embodiments.

At stage 2, additives 208 are mixed (blended) with the blend 210 of EPDM and silicone formed in stage 1. The additives 208 may include compounding ingredients, such as reinforcing filler (reinforcing material, reinforcement material, filler material) and curatives. The reinforcing filler may include particles and/or fibers. The reinforcing filler material (reinforcement material) may include, for example, carbon (e.g., carbon black), silica (silicon dioxide or SiO₂) particles, cotton fibers, aramid fibers, glass fibers, and so on. The reinforcing filler may be, for example, in the range of 0% to 50% by weight of the polymer blend 214 formed in stage 2. The curatives may advance or promote the vulcanization (crosslinking) of the EPDM 202 and the vulcanization (crosslinking) of the silicone 204. The curatives may include, for example, peroxide, sulfur, accelerators, etc.

The additives 208 may include softeners to reduce viscosity of the EPDM 202 (e.g., continuous phase in the blends 210, 214) to promote dispersion of the silicone 204 in the EPDM 202 by making the viscosity of the EPDM 202 more similar to the viscosity of the silicone 204.

At stage 2, at least one mixer 212 is utilized to blend the additives 208 with the first stage blend 210. As with the mixer 206 in the first stage, the mixer 212 (blender) in the second stage can be, for example, a two roll mill (e.g., FIG. 3) or an internal mixer (e.g., FIG. 4), or similar mixer. In some examples, the mixer 206 can be utilized to perform the second stage mixing and thus act as the mixer 212.

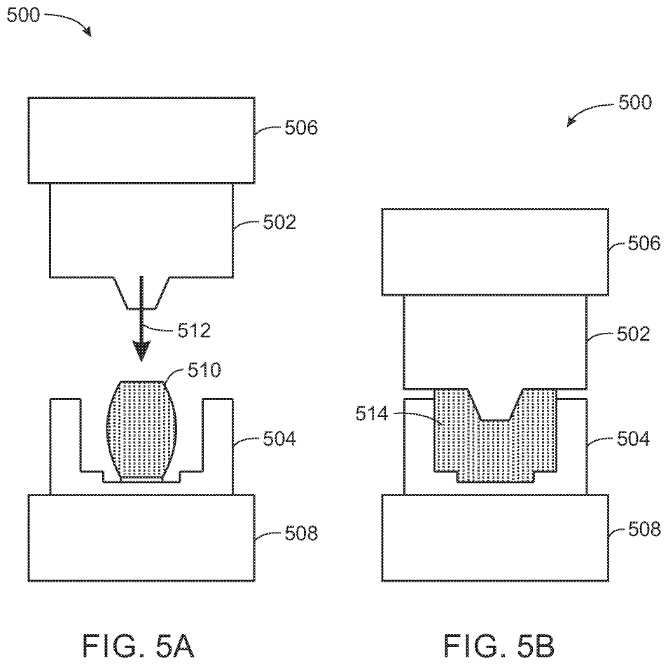

At stage 3, a downhole tool component is formed (such as via transfer molding or compression molding. e.g., FIGS. 5A-5B) from the blend 214 of the EPDM 202, the silicone 204, and the additives 208 formed in the second stage. Thus, the component (or portion of the component) for the downhole tool is or has (includes) a blend of EPDM and silicone. As discussed, the component can be, for example, a seal (scaling element) or other type of elastomeric or elastomeric-like component. The component as a blend of EPDM and silicone can have the filler material in the ranges of 0% to 50% by weight or 1% to 50% by weight.

At stage 3, the forming of the component (for the downhole tool) having the EPDM/silicone blend can be through elastomer manufacturing techniques. These techniques include, for example, extrusion, calendaring, strip wrapping/roll building, injection molding, transfer molding, compression molding, and so forth. For the blend 214 from stage 2 and for the blend of EPDM and silicone in the downhole tool component, the combined amount of the EPDM and the silicone is at least 45% by weight of the blend, such as in the ranges of 45% to 60%, 45% to 80%, 45% to 90%, 45% to 95%, and 45% to 99%.

An embodiment is a method that includes preparing a component (e.g., sealing element, a seal, a bonded seal, an O-ring. V-packing, a T-seal, or any combinations thereof) for a downhole tool for a wellbore in geothermal service, wherein the preparing includes: blending EPDM and silicone to give a first blend; blending an additive (e.g., filler material, softener, curative, etc.) with the first blend to give a second blend; molding the second blend to form the component; and vulcanizing the EPDM and the silicone in the second blend during molding the second blend to form the component. In implementations, blending the EPDM and the silicone to give the first blend includes blending the EPDM and the silicone via a two roll mill or an internal blender. In implementations, the molding of the second blend includes transfer molding or compression molding. The weight ratio of the EPDM to the silicone in the first blend and in the second blend can be in a range of 5:95 to 40:60. In implementations, the EPDM and the silicone (combined amount) are at least 45% by weight of the second blend.

In implementations, the additive blended with the first blend to give a second blend includes reinforcing filler material that can be particles or fibers, or both, and wherein the second blend includes the reinforcing material in a range of 1% to 50% by weight. In implementations, the additive includes a softener that reduces viscosity of the EPDM. In implementations, the method includes applying heat to the second blend during the molding, wherein the additive includes a curative that promotes the vulcanizing of the EPDM and the silicone, and wherein the heat promotes the vulcanizing of the EPDM and the silicone.

FIG. 3 is an example of a two roll mill 300 that can be utilized as a mixer to blend EPDM and silicone, as discussed with respect to stage 1 and/or stage 2 of FIG. 2. The two roll mill 300 may be labeled as a two roll mixing mill or a two roll rubber mill. A two roll mill includes two horizontally opposed stainless steel rolls that rotate in opposite directions, at different speeds. The rolls rotate towards each other, one faster than the other. The distance between the two rolls can also be adjusted by the operator. The opposing rotation directions and different speeds produce a combined shear and compression force on the material being mixed on the mill. With the two roll mill as an open roll rubber mill, the operator may add ingredients to the combination of EPDM and silicone while being mixed on the mill. For instances of chemical reactions occurring during the process of mixing that generates heat, one of the rolls can be hollow and coupled to a cooling water supply line for cool water to flow through the roll, cooling the metal roll and therefore the rubber or elastomer blend.

Again, a two roll mill includes two horizontally placed hollow metal rolls rotating towards each other. The distance between the mill rolls can be varied and this gap is known as nip. The speed difference between the rolls is called friction ratio and facilitates the shearing action. In implementations, the back roll moves faster than the front roll. Two roll mill mixing is also known as open mill mixing. A provision may be made in relation to any static electricity discharge in the two roll mill when silicone is blended.

FIG. 4 is an example of an internal mixer 400 that can be utilized to blend EPDM and silicone, as discussed with respect to stage 1 and/or stage 2 of FIG. 2. An internal mixer (e.g., a Banbury Mixer®) is a machine utilized to mix rubber or rubber-like compounds (or elastomers in embodiments herein). The internal mixer includes a chamber to which compounding ingredients may be added. The rolls of internal mixers are known as rotors. In the chamber are two rotors that generate shear forces, dispersing the fillers and other raw materials in the polymer (elastomer, rubber, or rubber-like compounds) being mixed (blended). The generation of the shear forces can promote giving a uniform blend. In implementations, after a defined mixing period, the compound (blend) may be dropped onto a mill or extruder where mixing is completed and the stock sheeted out for ease of handling. Processing parameters in internal mixing may include, for example, batch size, sequence of loading, ram pressure, rotor speed, mixing time, and temperature of mixing. An advantage of an internal mixer may be doing away with an initial step of roller-milling. Internal mixers can be utilized for incorporating reinforcing fillers in the resin system.

Two different types of internal mixers include Banbury and intermix. The Banbury mixer is an internal batch mixer that includes two rotating spiral-shaped blades encased in segments of cylindrical housings. The blades intersect giving a ridge between the blades. The blades may be cored for circulation of heating or cooling.

FIGS. 5A and 5B are a compression mold 500. FIG. 5A depicts the mold 500 in an open position. FIG. 5B depicts the mold in a closed position. In the illustrated example, the compression mold 500 includes an upper mold half 502, a lower mold half 504, a top heated platen 506, and a bottom heated platen 508.

FIG. 5A is the compression mold 500 as opened to receive the blend 510 (e.g., 214 in FIG. 2) of EPDM and elastomer. In FIG. 5A, the blend 510 is placed in the open mold 500 in the lower mold half 502. In this implementation, the upper mold half 502 is moved, as indicated by arrow 512, to meet the lower mold half 504 and thus close the mold 500.

FIG. 5B depicts the mating of the upper mold half 502 and the lower mold half 504 giving a mold cavity facilitating forming the shape of the molded product 514. The heat applied by the top heated platen 506 and the lower heated platen 508 can promote curing (vulcanization, crosslinking) of the blend 510 including via any curatives in the blend 510. Subsequently, the mold 500 can be opened and the compression molded product 514 removed from the mold 500. The compression molded product 514 can be the component (or a portion of the component) for the downhole tool (e.g., 102 of FIG. 1) in geothermal service.

In general, compression molding is a type of molding that uses both pressure and heat. The raw material (e.g., the blend of EPDM, silicone, and any filler or additives) is inserted into the heated mold chamber for compression molding. Plugs may then be placed into the top of the mold cavity to seal and pressurize the mold chamber. The raw material starts to cure inside the mold cavity as advanced by exposure to heat and pressure, creating a new product or component. Compression molding may be a good choice for difficult-to-flow materials and/or for materials having long curing times.

Compression molding can utilize pre-formed material (elastomers) to mold the elastomers. After uncured rubber or polymer (elastomer) is placed in the mold cavity, the compression mold is closed and heat and pressure are applied. When the cavity is filled, excess material fills the mold overflow grooves. After any curing is complete and the mold is opened, demolding is performed to remove any flashing.

In transfer molding, the charge is heated in the outside loading chamber whereas in compression mold the charge is heated and pressurized in the same mold. Transfer molding is a manufacturing technique that entails pressing a casting material (elastomer such as the blend 214, 510) into a closed mold. Transfer molding is distinct from compression molding in that transfer molding uses an enclosed mold. Transfer molding may involve transferring a measured amount of material, in a preheated and softened state, into a closed mold cavity under pressure. The material is then cured or solidified to form the desired shape.

The blend of EPDM and silicone generally provides an elastomer formulation with relatively high temperature stability and good steam resistance while maintaining high-pressure sealing extrusion resistance. Implementations of the EPDM-silicone rubber formulation can offer these improvements with the benefit of employing conventional elastomer manufacturing equipment.

The present blend design (of EPDM and silicone) is for sealing materials for geothermal applications with high temperature demands. Blends of up to 40% by weight of silicone or liquid silicone rubber are practical for use.

Any typical seal configuration/design can utilize the present blends including (1) thin cross-sectional seals like O-rings, V-Packing, T-seals and bonded/molded seals or (2) thicker cross-sectional seals like packing elements, rotating control device (RCD) elements, swell packers, and bonded expandable liner hangers.

The blends may have limited performance where significant hydrocarbon exposure is expected. However, fluorosilicone elastomer and/or liquid FEPM elastomer can be used in place of silicone rubber for some improvement in oil resistance.

EPDM blends with alternative reactive polymers like liquid polybutadiene co-cure with the EPDM and can be employed to reduce the modulus increases typical for EPDM aging at extreme temperatures. Moreover, FFKM or FEPM may be used but compatibilizers or fluorosilicone would be implemented to improve compatibly and co-curing.

### Example

This Example is given only an example and not meant to limit the present techniques. In the Example, EPDM was blended with silicone at different loadings of the silicone. Properties of the original blends of EPDM and silicone were measured. The results are presented below in Table 2. The blends were steam aged for 7 days at 175° C. Properties of the steam-aged blends of EPDM and silicone were measured. The percent (%) change in the properties of the steam-aged blends compared to the original blends is given in Table 3.

To prepare the original blends, the EPDM-silicone blends were mixed utilizing a two roll mill. Test slabs were prepared through compression molding. Test specimens were prepared from the test slabs using a cutting die per American Society for Testing and Materials (ASTM) standard D412-16 “Standard Test Methods for Vulcanized Rubber and Thermoplastic Elastomers—Tension” (last updated Jun. 25, 2021) of ASTM international. For the steam aging, coupons of the test slabs were aged in a Parr autoclave available from Parr Instrument Company having headquarters in Moline, Illinois, USA. The changes in properties due to the steam aging were tested to the aforementioned ASTM D412-16.

In Table 2 and Table 3, the properties are Tb, Eb, 25M, 50M, and 100M. Tb, in pounds per square inch (psi), is the ultimate tensile strength at break and is the maximum stress (psi) a material can withstand before breaking. Eb, in percent (%), is elongation at break also known as strain at break. 25M (in psi), 50M (in psi), and 100M (in psi) are labeled as clastic modulus (modulus of elasticity or Young's modulus) at 25% strain, 50% strain, and 100% strain, respectively, and are tensile stress at 25% strain, 50% strain, and 100% strain, respectively.

The units of 25M, 50M, and 100M are pressure units, as they are defined as stress (pressure units) divided by strain (dimensionless). 25M, 50M, and 100M are indicative of resistance to being deformed elastically when stress is applied, and thus indicative of stiffness or how easily the material can be bent or stretched. A lower modulus can be beneficial so that the blend is less brittle. Being too brittle material generally does not make for a good seal.

In Table 2 and Table 3 below, the silicone loading is in parts per hundred rubber (phr). For 0 phr, there is no blend but is all EPDM and no silicone. For 100 phr, there is no blend but is all silicone and no EPDM.

TABLE 2
Original properties of EPDM blends
with increasing Silicone Loading

Silicone Loading (phr)

| | 0 | 5 | 10 | 20 | 30 | 100 |
|---|---|---|---|---|---|---|
| Tb | 1660 | 1592 | 1510 | 1330 | 1252 | 826 |
| Eb | 255 | 272 | 266 | 256 | 234 | 42 |
| 25M | 178 | 203 | 151 | 170 | 197 | 682 |
| 50M | 262 | 260 | 218 | 240 | 286 | |
| 100M | 506 | 416 | 394 | 419 | 499 | |

TABLE 3
Steam Aged property changes of EPDM blends
with increasing Silicone Loading

| | Silicone Loading (phr) | | | | | |
|---|---|---|---|---|---|---|
| | 0 | 5 | 10 | 20 | 30 | 100 |
| Tb change | −12.5% | −18.7% | −18.3% | −22.8% | −42.3% | −32.9% |
| Eb change | 14.1% | 6.6% | 6.4% | 14.1% | −4.3% | −28.6% |
| 25M change | −9.6% | −33.0% | −0.7% | 2.4% | 3.6% | |
| 50M change | −13.4% | −29.2% | −6.9% | −4.6% | −8.0% | |
| 100M change | −19.2% | −29.6% | −17.0% | −17.9% | −22.6% | |

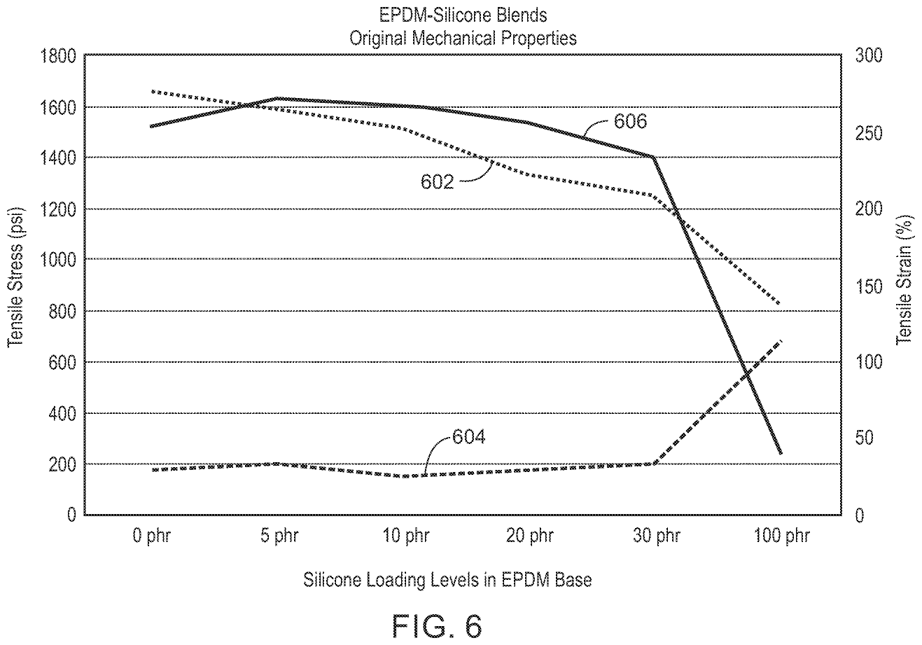

FIG. 6 is a plot 600 of tensile stress (psi) and tensile strain (%) over the silicone loading (phr) of the original blends of EPDM and silicone, and gives curves for Tb, 25M, and Eb from Table 2. The curve 602 is Tb with numerical values read from the tensile stress (psi) axis. The curve 604 is for 25M with numerical values read from the tensile stress (psi) axis. The curve 606 is for Eb with numerical values read from the tensile stain (%) axis.

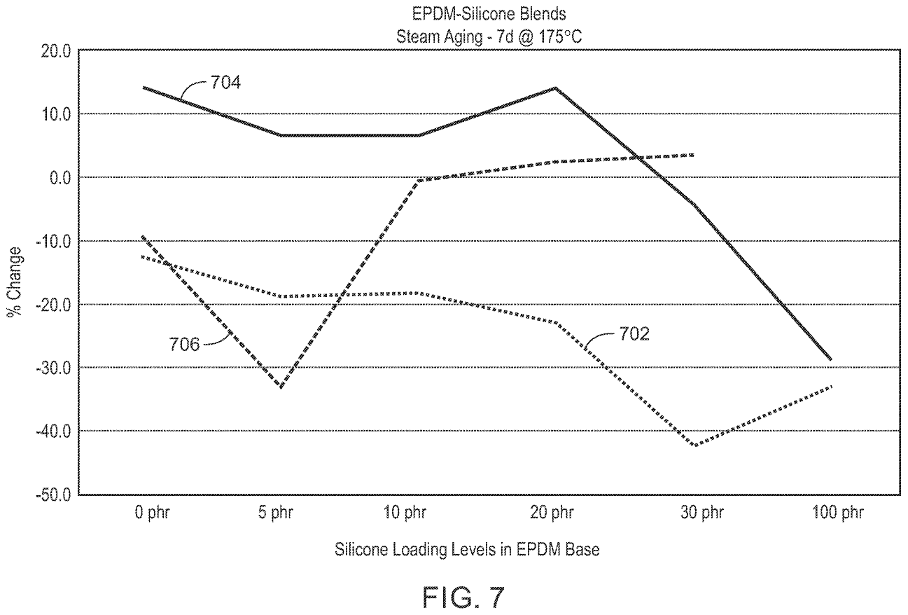

FIG. 7 is a plot 700 of percent change over silicon loading levels in the EPDM, and gives curves for Tb change, 25M change, and Eb change from Table 3. The curve 702 is percent change in Tb. The curve 704 is percent change in Eb. The curve 706 is percent change in 25M. Again, the change is from original to steam aged, as discussed and presented with respect to Tables 2 and 3.

In view of the foregoing, the present disclosure may provide a downhole tool for a wellbore in geothermal service, the downhole tool having a component including a blend of EPDM and silicone, wherein the blend is vulcanized. The methods, systems, and tools may include any of the various features disclosed herein, including one or more of the following statements.
Statement 1. A downhole tool for a wellbore in geothermal service, the downhole tool having a component comprising a blend of ethylene propylene diene monomer (EPDM) and silicone, wherein the blend is vulcanized.
Statement 2. The downhole tool of Statement 1, wherein a weight ratio of the EPDM to the silicone is in a range of 5:95 to 40:60, and wherein a combined amount of the EPDM and the silicone is at least 45% by weight of the blend.
Statement 3. The downhole tool of any preceding Statement, wherein the blend comprises reinforcing filler material in a range of 1% to 50% by weight, and wherein the reinforcing filler material comprises particles or fibers, or both.
Statement 4. The downhole tool of Statement 3, wherein the reinforcing filler material comprises carbon black, silica particles, cotton fibers, aramid fibers, or glass fibers, or any combinations thereof.
Statement 5. The downhole tool of any preceding Statement, wherein the blend comprises a softener that reduces viscosity of the EPDM.
Statement 6. The downhole tool of any preceding Statement, wherein the component comprises a sealing element, a seal, a bonded seal, a custom-molded seal, an O-ring, V-packing, a T-seal, a valve, or an injection port, or any combinations thereof.
Statement 7. The downhole tool of any preceding Statement, wherein the downhole tool comprises a packer, a plug, an expandable liner hanger (ELH), a rotating control device (RCD), a valve, or an injection port, or any combinations thereof.
Statement 8. A method comprising preparing a component for a downhole tool for a wellbore in geothermal service, wherein the preparing comprises: blending ethylene propylene diene monomer (EPDM) and silicone to give a first blend; blending an additive with the first blend to give a second blend; molding the second blend to form the component; and vulcanizing the EPDM and the silicone in the second blend during molding the second blend to form the component.
Statement 9. The method of Statement 8, wherein blending the EPDM and the silicone to give the first blend comprising blending the EPDM and the silicone via a two roll mill or an internal blender.
Statement 10. The method of Statement 8 or 9, wherein the molding comprises transfer molding or compression molding.
Statement 11. The method of any one of Statements 8-10, wherein a weight ratio of the EPDM to the silicone in the first blend and in the second blend is in a range of 5:95 to 40:60, and wherein the EPDM and the silicone are at least 45% by weight of the second blend.
Statement 12. The method of any one of Statements 8-11, wherein the additive comprises reinforcing filler material comprising particles or fibers, or both, and wherein the second blend comprises the reinforcing material in a range of 1% to 50% by weight.
Statement 13. The method of any one of Statements 8-12, wherein the additive comprises a softener that reduces viscosity of the EPDM.
Statement 14. The method of any one of Statements 8-13, comprises applying heat to the second blend during the molding, wherein the additive comprises a curative that promotes the vulcanizing of the EPDM and the silicone, and wherein the heat promotes the vulcanizing of the EPDM and the silicone.
Statement 15. The method of any one of Statements 8-14, wherein the component comprises a sealing element, a seal, a bonded seal, an O-ring. V-packing, a T-seal, or any combinations thereof.
Statement 16. A method of deploying a downhole tool into a geothermal wellbore, comprising: lowering the downhole tool into the geothermal wellbore, the downhole tool having a component comprising a blend of ethylene propylene diene monomer (EPDM) and silicone, wherein a weight ratio of the EPDM to the silicone is in a range of 5:95 to 40:60, and wherein the EPDM and the silicone are vulcanized; and positioning the downhole tool at a target location in the geothermal wellbore.
Statement 17. The method of Statement 16, wherein the blend comprises reinforcing filler material in a range of 1% to 50% by weight, wherein the reinforcing filler material comprises particles or fibers, or both, and wherein a combined amount of the EPDM and the silicone is at least 45% by weight of the blend.
Statement 18. The method of Statement 16 or 17, wherein the component comprises a sealing element, a seal, a bonded seal, an O-ring, V-packing, a T-seal, or any combinations thereof.
Statement 19. The method of any one of Statements 16-18, wherein the downhole tool comprises a packer, a plug, an expandable liner hanger (ELH), a rotating control device (RCD), or a valve, or any combinations thereof.
Statement 20. The method of any one of Statements 16-19, wherein the EPDM and the silicone are blended via a two roll mill or an internal mixer to give the blend, wherein the component is formed by molding the blend, and wherein the molding comprises transfer molding or compression molding.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A downhole tool for a wellbore in geothermal service, the downhole tool having a component comprising a blend of ethylene propylene diene monomer (EPDM) and silicone, wherein the blend is vulcanized.

2. The downhole tool of claim 1, wherein a weight ratio of the EPDM to the silicone is in a range of 5:95 to 40:60, and wherein a combined amount of the EPDM and the silicone is at least 45% by weight of the blend.

3. The downhole tool of claim 1, wherein the blend comprises reinforcing filler material in a range of 1% to 50% by weight, and wherein the reinforcing filler material comprises particles or fibers, or both.

4. The downhole tool of claim 3, wherein the reinforcing filler material comprises carbon black, silica particles, cotton fibers, aramid fibers, or glass fibers, or any combinations thereof.

5. The downhole tool of claim 1, wherein the blend comprises a softener that reduces viscosity of the EPDM.

6. The downhole tool of claim 1, wherein the component comprises a sealing element, a seal, a bonded seal, a custom-molded seal, an O-ring, V-packing, a T-seal, a valve, or an injection port, or any combinations thereof.

7. The downhole tool of claim 1, wherein the downhole tool comprises a packer, a plug, an expandable liner hanger (ELH), a rotating control device (RCD), a valve, or an injection port, or any combinations thereof.

8. A method comprising:
preparing a component for a downhole tool for a wellbore in geothermal service, wherein the preparing comprises:
blending ethylene propylene diene monomer (EPDM) and silicone to give a first blend;
blending an additive with the first blend to give a second blend;
molding the second blend to form the component; and
vulcanizing the EPDM and the silicone in the second blend during molding the second blend to form the component.

9. The method of claim 8, wherein blending the EPDM and the silicone to give the first blend comprising blending the EPDM and the silicone via a two roll mill or an internal blender.

10. The method of claim 8, wherein the molding comprises transfer molding or compression molding.

11. The method of claim 8, wherein a weight ratio of the EPDM to the silicone in the first blend and in the second blend is in a range of 5:95 to 40:60, and wherein the EPDM and the silicone are at least 45% by weight of the second blend.

12. The method of claim 8, wherein the additive comprises reinforcing filler material comprising particles or fibers, or both, and wherein the second blend comprises the reinforcing material in a range of 1% to 50% by weight.

13. The method of claim 8, wherein the additive comprises a softener that reduces viscosity of the EPDM.

14. The method of claim 8, comprises applying heat to the second blend during the molding, wherein the additive comprises a curative that promotes the vulcanizing of the EPDM and the silicone, and wherein the heat promotes the vulcanizing of the EPDM and the silicone.

15. The method of claim 8, wherein the component comprises a sealing element, a seal, a bonded seal, an O-ring, V-packing, a T-seal, or any combinations thereof.

16. A method of deploying a downhole tool into a geothermal wellbore, comprising:
lowering the downhole tool into the geothermal wellbore, the downhole tool having a component comprising a blend of ethylene propylene diene monomer (EPDM) and silicone, wherein a weight ratio of the EPDM to the silicone is in a range of 5:95 to 40:60, and wherein the EPDM and the silicone are vulcanized; and
positioning the downhole tool at a target location in the geothermal wellbore.

17. The method of claim 16, wherein the blend comprises reinforcing filler material in a range of 1% to 50% by weight, wherein the reinforcing filler material comprises particles or fibers, or both, and wherein a combined amount of the EPDM and the silicone is at least 45% by weight of the blend.

18. The method of claim 16, wherein the component comprises a sealing element, a seal, a bonded seal, an O-ring, V-packing, a T-seal, or any combinations thereof.

19. The method of claim 16, wherein the downhole tool comprises a packer, a plug, an expandable liner hanger (ELH), a rotating control device (RCD), or a valve, or any combinations thereof.

20. The method of claim 16, wherein the EPDM and the silicone are blended via a two roll mill or an internal mixer to give the blend, wherein the component is formed by molding the blend, and wherein the molding comprises transfer molding or compression molding.
